(19) United States
(12) Patent Application Publication
(10) Pub. No.: US 2016/0289059 A1
(43) Pub. Date: Oct. 6, 2016

(54) Liquid Dispenser Caddy

(71) Applicant: Prince Castle LLC, Carol Stream, IL (US)

(72) Inventors: Calvin S. Nelson, Round Lake Beach, IL (US); Eugene S. Maslana, Morton Grove, IL (US); Christopher Lyons, LaGrange Park, IL (US); Michael A. Graef, Naperville, IL (US); Sean Sanders, Chicago, IL (US)

(73) Assignee: Prince Castle LLC, Carol Stream, IL (US)

(21) Appl. No.: 14/941,859

(22) Filed: Nov. 16, 2015

Related U.S. Application Data
(60) Provisional application No. 62/140,142, filed on Mar. 30, 2015.

(51) Int. Cl. B67D 1/08; G01G 19/52; B67D 1/12; B67D 1/00; B67D 1/06

(52) U.S. Cl. CPC B67D 1/0891; B67D 1/0001; B67D 1/06; B67D 1/0888; B67D 1/1279; G01G 19/52

(57) ABSTRACT

A caddy for use in supporting a flexible bag of a substance to dispense as well as a system for dispensing a substance include a front wall and a back wall. A floor extends between the front wall and the back wall and angles from the back wall in a direction towards the front wall a cradle is connected to the floor and the cradle opens in a downward direction and a rearward direction. A dispenser includes a cabinet, a load cell, a valve, and a processor. The cradle engages the load cell and the processor calculates a valve open time at least in part based upon a measurement of a load impressed upon a load cell and a requested dispense volume. The processor operates the valve to open for the calculated valve open time.

### CROSS-REFERENCE TO RELATED APPLICATION

The present application claims priority of U.S. Provisional Patent Application No. 62/140,142, filed on Mar. 30, 2015, the content of which is hereby incorporated herein by reference in its entirety.

### BACKGROUND

The present disclosure relates to the field of liquid dispensing. More particularly, the present disclosure relates to a caddy for the dispense of liquid held in a bag.

Liquids dispensed in restaurant and/or food service settings are often provided from a supply contained in a sealed bag. Such liquids may include, but are not limited to milk, cream, premixed beverages such as tea and punch, fruit juices, or flavored syrups. Dispensers for these bulk bags of liquid are known. Typically, the bags are held in a generally vertical orientation to improve dispense of the liquid due to gravity. The bags may either be suspended from hooks or other fasteners in the top of a dispenser cabinet or the bags may be placed in a top loading supportive trough. The bags typically include a fitment in one side from which a flexible tube extends. The liquid is dispensed from the bag through the flexible tube. In supportive troughs, the flexible tube must be fed through a hole in the bottom of the trough to be properly fed into the dispenser. Loading of the system requires the user to suspend the bag of liquid with one hand from the top of the trough while reaching into the bottom of the trough in order to properly locate the flexible tube out of the bottom.

Recently, liquid dispensers that use a load cell to assist in portion and dispense control have been developed. Therefore, solutions that can adapt bagged liquid for easier loading, dispensing, and repeatable engagement with such load cells are also desired.

### BRIEF DISCLOSURE

An exemplary embodiment of a caddy is used to support a flexible bag of a substance to dispense. The caddy includes a front wall. A back wall is opposite the front wall. The caddy includes a first side wall and a second side wall. A floor extends between the front wall and the back wall. The floor angles from the back wall in a direction towards the front wall.

A cradle is connected to the floor, the cradle opens in a downward direction and a rearward direction.

An exemplary embodiment of a system for dispensing substance includes a dispenser, a caddy, and a flexible bag. The dispenser includes at least a cabinet, a load cell, a valve, and a processor. The processor calculates a valve open time at least in part based upon a measurement of a load impressed upon the load cell and a requested dispense volume. The processor operates the valve to open for the valve open time. A caddy includes a front wall, a back wall opposite the front wall, a first side wall, and a second side wall. A floor extends between the front wall and the back wall. The floor angles from the back wall in a direction towards the front wall. A cradle is connected to the floor. The cradle opens in a downward direction and a rearward direction to engage the load cell. The flexible bag is disposed within the caddy and contains a substance to be dispensed, a flexible tube extends from the flexible bag and is connected to the valve.

### BRIEF DESCRIPTION OF THE DRAWINGS

FIG. 1 is a perspective view of an exemplary embodiment of a caddy for use with a bag of liquid in a liquid dispenser.

FIG. 2 is a bottom view of the caddy of FIG. 1.

FIG. 3 is a perspective view of an exemplary embodiment of a liquid dispenser with the door removed.

FIG. 4 is a close-up view of a caddy positioned within a dispenser.

FIG. 5 is a side sectional view of an exemplary embodiment of a caddy being loaded into a dispenser.

FIG. 6 is a side sectional view of a dispenser with a caddy loaded therein.

FIG. 7 depicts an exemplary side perspective view of an embodiment of a caddy with a bag of liquid positioned therein.

FIG. 8 is a side sectional view of an additional exemplary embodiment of a caddy positioned within a cabinet of a dispenser.

FIG. 9 is a perspective sectional view of the additional exemplary embodiment of a caddy positioned within a cabinet of a dispenser.

FIG. 10 is a perspective view of a further exemplary embodiment of a caddy.

FIG. 11 depicts an exemplary embodiment of a bag of liquid and support plate.

FIG. 12 is a bottom perspective view of the further exemplary embodiment of a caddy.

FIG. 13 depicts an exemplary embodiment of a support plate.

### DETAILED DESCRIPTION

As disclosed herein, embodiments of a caddy provide a removable support system for liquids supplied in a bag to be dispensed from a dispensing machine. Embodiments disclosed herein are particularly suited to facilitate the use of bagged liquids for dispense in dispensers configured to use a load cell to control dispense operations.

Some embodiments enable improved ease in loading and unloading of bagged liquids into a dispenser, particularly in relation to a load cell in a dispenser used to assist in the dispense of the liquid.

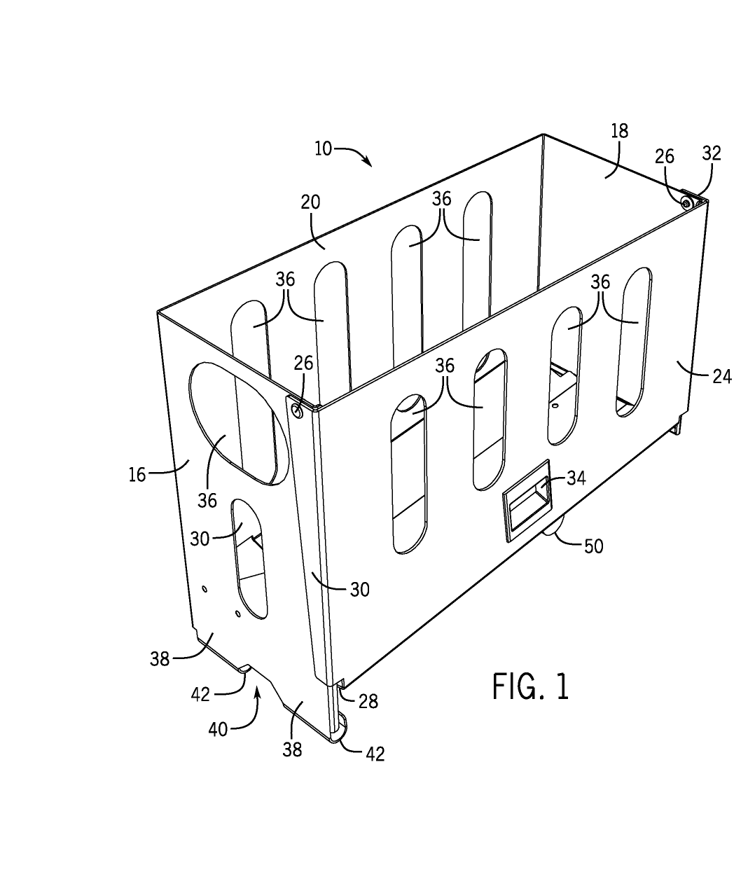

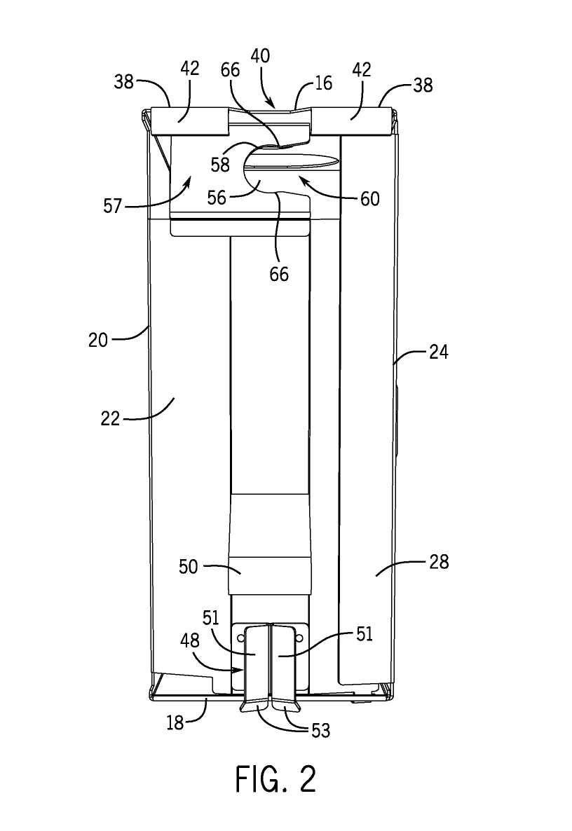

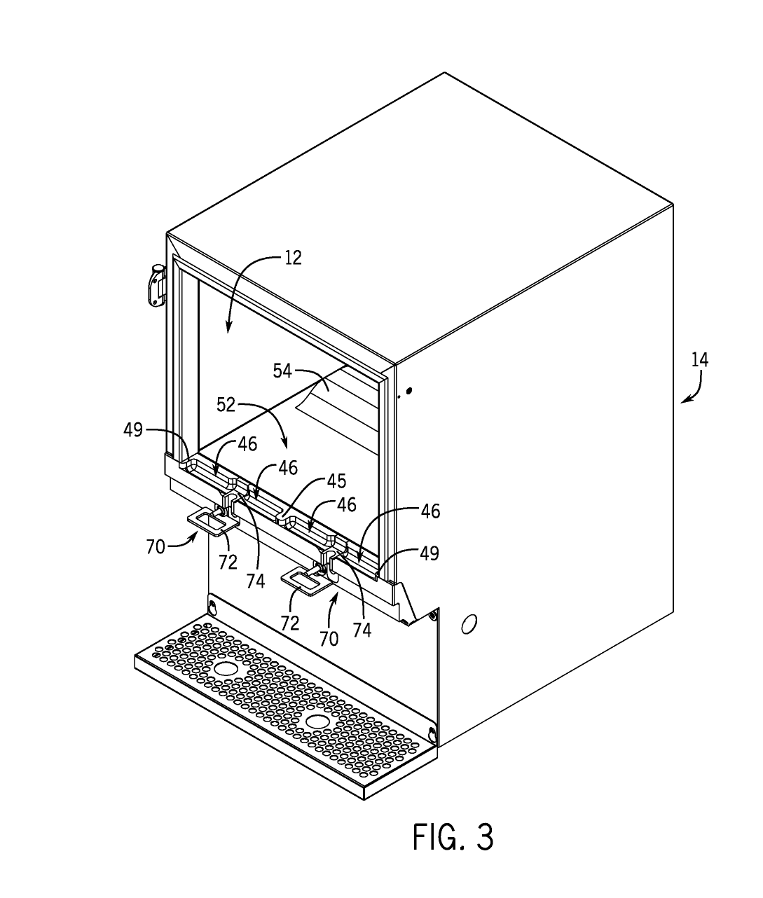

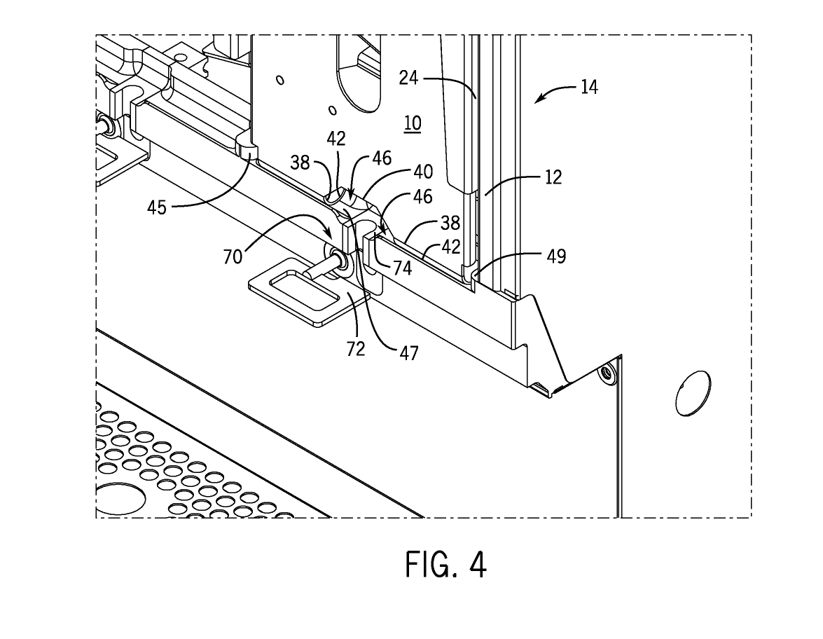

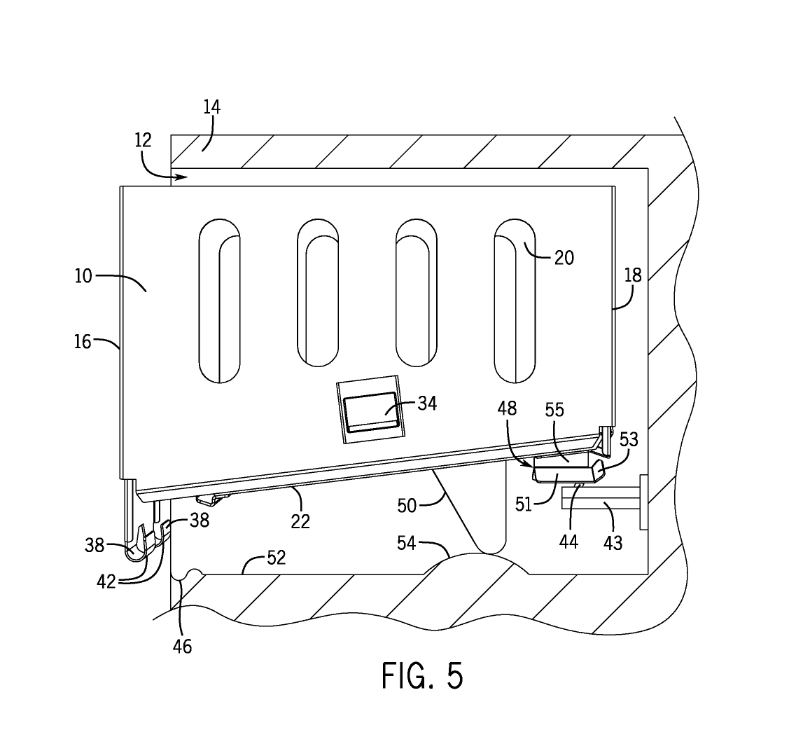

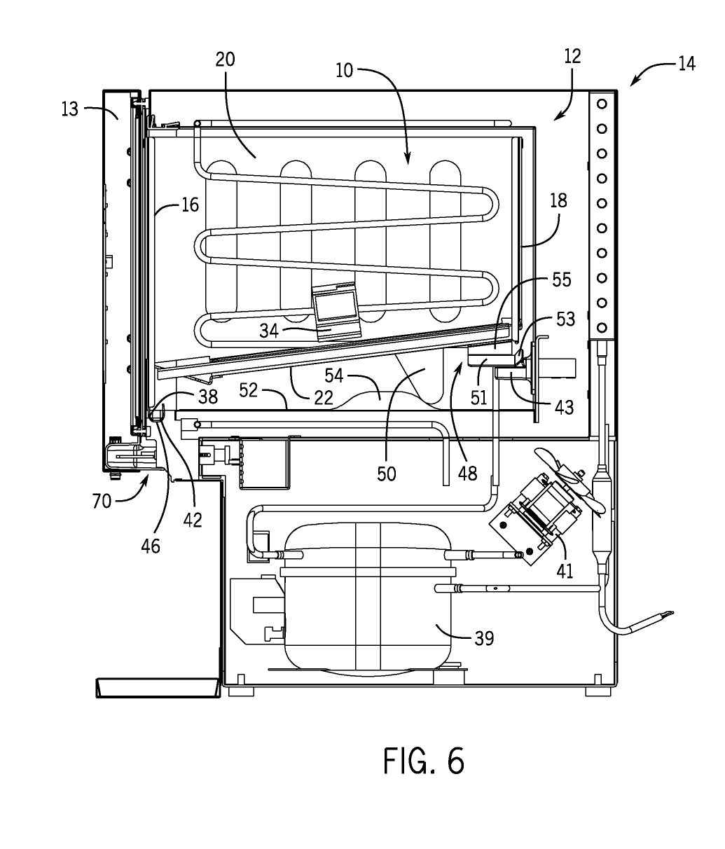

FIG. 1 is a perspective view of an exemplary embodiment of a bag caddy 10. FIG. 2 is a bottom view of the bag caddy 10. FIG. 3 is an exemplary perspective view of the dispenser 14 with a door (not depicted) removed. FIG. 4 is a close up view of a bag caddy 10 positioned within a cabinet 12 of a dispenser 14. FIGS. 5 and 6 are sectional side views of an embodiment of a bag caddy 10 positioned within a cabinet 12 of a dispenser 14. Exemplary embodiments of dispensers and cabinets are described in further detail in U.S. Pat. No. 8,534,497 entitled, “Dispensing Method and Apparatus Utilizing a Senor to Determine a Time That a Dispensing Valve is Open” and U.S. Pat. No. 8,844,768 entitled, “Liquid Dispenser with Storage Tank,” both of which are incorporated herein by reference in their entireties.

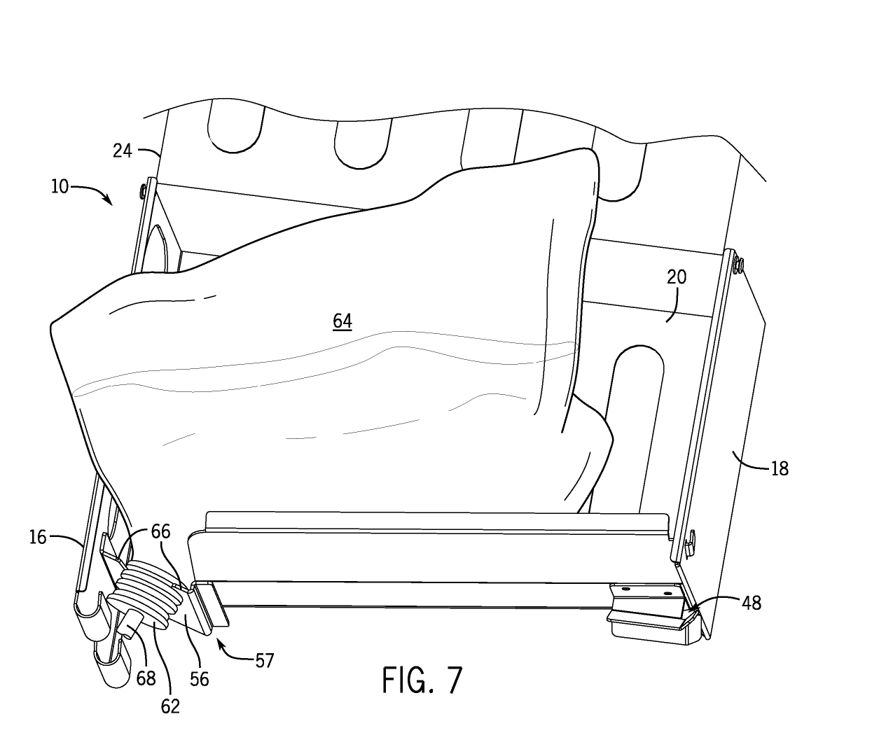

Referring to FIGS. 1 and 2, the bag caddy 10 includes a front wall 16, a back wall 18, and a side wall 20. Each of front wall 16, back wall 18, and side wall 20 extend generally vertically and the front wall 16 is generally larger than the back wall 18 in the manner as described in further detail herein. A floor 22 is connected to the front wall 16, back wall 18, and side wall 20. The floor 22 generally slopes downwards in a direction from the back wall 18 to the front wall 16 as best shown in FIG. 5. Another side wall is located opposite side wall 20 and is exemplarily embodied by side door 24. Side door 24 is pivotably secured to the front wall 16 and the back wall 18, exemplarily by pivot pin 26, although it will be recognized that the side door 24 may be pivotably secured in other manners as well. The side door 24 is pivotably moveable between a closed position as exemplarily depicted in FIG. 1, and an open position as exemplarily depicted in FIG. 7. While not depicted, further embodiments that include the side door 24 may also include a ceiling to the caddy, with access to the interior of the caddy provided through the side door 24.

The side door 24 further includes a bottom lip 28 which may be configured to engage a bottom side of the floor 22 when the side door 24 is in the closed position. In an exemplary embodiment, the bottom lip 28 may be configured such as to engage the bottom side of the floor 22 with a friction fit to hold the side door 24 in a closed position. In embodiments, the side door may further include a front lip 30 and a back lip 32. The front lip 30 may be configured to respectively engage the front wall 16 while the back lip 32 is configured to engage the back wall 18. The front lip 30 and the back lip 32 can facilitate alignment of the side door 24 respectively with the front wall 16 and the back wall 18 as the side door 24 is moved between opened and closed positions.

The front lip 30 and the back lip 32 can further provide strength and rigidity to the bag caddy 10 when the side door 24 is in the closed position.

In an additional exemplary embodiment, the side door 24 may be moveably secured to the front wall 16 and back wall 18 by engagement of pins 26 or a similar structure with an exemplarily “L”-shaped track that facilitates vertical translation of the side door 24, followed by horizontal translation and/or pivoting about the pins 26 to open the side door 24. In such an embodiment, the side door 24 may further include tabs (not depicted) that extend downwardly from a lower end of the side door 24 that engage at least one slot or ridge (not depicted) on the floor 22 to retain the side door 24 in the closed position.

In embodiments, the side door 24 may further include a handle 34 disposed thereon. The handle 34 facilitates gripping of the side door 24 to move the side door 24 between the open and closed positions.

Embodiments of the bag caddy 10 may further include openings 36 located through one or more of the front wall 16, back wall 18, side wall 20, and side door 24. In embodiments, the openings 36 can facilitate a user inspection of a remaining amount of liquid in a bag placed in the bag caddy 10. Embodiments of the openings 36 further reduce weight of the bag caddy 10 and can also promote air circulation about a bag of liquid disposed within the bag caddy 10.

The bag caddy 10 further includes at least one foot 38, and in embodiments, at least two feet 38 which extend from the front wall 16. In other embodiments, the feet 38 may extend from an area of the bag caddy 10 about the front wall 16 while not necessarily integral with or directly connected to the front wall 16. The feet 38 may be separated by a cut-out 40 which facilitates use with a bag of liquid as described in further detail herein. The feet 38 may each further include an end 42. The end 42 may exemplarily be rounded in shape. In an embodiment, the rounded end 42 is formed by bending the material of the feet 38. In other embodiments, the end 42 may take other shapes as will be recognized by a person of ordinary skill in the art. As will be described in further detail herein, embodiments of the bag caddy 10 are configured to facilitate use of the bag caddy 10 with a dispenser configured to control the dispense of liquid from the bag based at least in part upon a load impressed upon a load cell by a portion of the bag caddy 10. In an embodiment, the rounded ends 42 of the feet 38 engage a portion of the dispenser 14 as will be described in further detail herein. Exemplarily, the feet 38 engage a trough, which may also be a lip or a ledge, of the dispenser to accurately and repeatably locate the bag caddy 10 within the cabinet with respect to a load cell.

FIG. 4 depicts a close up view of a bag caddy 10 inserted within the cabinet 12 of a dispenser 14. The feet 38 of the bag caddy 10 engage the dispenser 14 in a trough 46 which is dimensioned to receive the feet 38. In an embodiment, a surface 47 of the trough 46 is shaped to matingly engage the ends 42 of the feet 38. The trough is positioned at a level below the floor 52 of the cabinet 12 and is configured to receive the rounded end 42 of the feet 38 of the bag caddy 10. The engagement of the feet 38 with the depression 46 help to further position the bag caddy 10 relative to the dispenser 14 and the load cell 44 in a manner that is consistent between cycle to cycle of loading and unloading the bag caddy 10 in the dispenser 14.

Mating engagement between the trough 46 and the ends 42 of the feet 38 define a single position and location for the feet 38 when the bag caddy 10 is fully inserted into the cabinet 12 as described in further detail herein. The dispenser 14 includes a pinch valve 70 that generally includes a pinch bar 72 and a tube seat 74. The tube seat 74 may exemplarily be a heat sink and further includes a curved position to receive a flexible tube from a bag positioned within the bag caddy. The pinch bar 72 applies an occluding force against the tube and upon operation of the dispenser 14, the pinch valve 70 moves the pinch bar 72 to release the occluding force on the flexible tube. Release of the occluding force resulting in a dispense of the liquid from the bag (not depicted) in operation of the dispenser. Exemplary embodiments of pinch valves are described in further detail in U.S. Pat. No. 8,636,180 entitled “Pinch Valve” and U.S. Pat. No. 8,376,310 entitled “Pinch Valve,” both of which are incorporated by reference in their entireties. The cut out 40, as described in further detail herein, facilitates positioning of the tube (not depicted) relative to the bag and to the pinch valve 70. In embodiments, the trough 46 extends in two or more portions, exemplarily on either side of the pinch valve 70 in order to accommodate the cutout 40 and the tube from the bag.

FIG. 3 depicts an exemplary embodiment of dispenser 14, without a door connected thereto for the purposes of clarity. It is understood that embodiments of the dispenser 14 include a door to close the cabinet that the door may take any of a variety of forms as would be recognized by a person of ordinary skill in the art. The dispenser 14 is exemplary arranged to receive two bag caddies (not depicted) within the cabinet 12 with each bag caddy engaging the troughs 46 with the respective feet of the bag caddies. In an exemplary embodiment, the troughs 46 are further dimensioned to match a width of a respective bag caddy, exemplarily by a divider 45 positioned between troughs 46 and/or end walls 49 at the ends of trough 46. The incorporation of the divider 45 and/or end wall 49 with the troughs 46 further to define a proper position or location of the bag caddy in a respective lateral dimension. As will be explained in further detail herein, in addition to defining a desired position and location of the bag caddy 10 within the cabinet 12, the ends 42 of the feet 38 pivotably engage the at least one trough 46 to facilitate measurement by a load cell of weight impressed upon the load cell by the bag caddy 10 as will be de sin further detail herein.

Referring back to FIG. 2, which is a bottom view of the bag caddy 10, the bag caddy 10 includes cradle 48 which extends downwardly from the floor 22 in an area about the back wall 18. The cradle 48 is exemplarily arranged to engage at least a portion of the load cell 44 which may be positioned on a sensor arm 43 (FIGS. 5 and 6). In an exemplary embodiment, the cradle 48 may be designed to have a keyed or mating relationship with at least a portion of the load cell 44 or sensor arm 43. In the embodiment depicted, the cradle 48 opens downwardly in a generally triangular shape, such triangular shape may generally corresponds to a triangular or trapezoidal portion of the sensor arm 43 about which the load cell 44 is located. Such an exemplary shape, while being recognized that other shapes may be used, not only facilitates engagement between the cradle 48 and the load cell 44, but also defines a lateral position and relationship between the cradle 48 and/or the bag caddy 10 as a whole with the load cell 44 and the bag caddy 10 within the cabinet 12. As will be described herein, other embodiments may use alternative arrangements of the cradle 48.

The cradle 48 exemplarily includes two arms 51, which as mentioned above, may exemplarily angle away from one another to form a generally triangular shape. It will be recognized that in other embodiments, the arms may be arranged in other manners. Flanges 53 exemplarily further extend outwardly from the arms 51. The flanges 53 extend in at least one of a direction away from the front of the bag caddy and/or towards the side walls of the bag caddy. It will be recognized that in the embodiment depicted in FIG. 2, the flanges 53 extend away from the arms 51 in both of these directions. The flanges 53 further facilitate centering of the cradle 48 upon the load cell 44, for example by an initial engagement with a sensor arm 43 during positioning of the bag caddy 10.

FIGS. 5 and 6 are exemplary cross sectional views of the bag caddy 10 within the cabinet 12 of the dispenser 14. These further depict the cradle 48 as well as an extension 55 that exemplarily connects the arms 51 of the cradle 48 to the underside of the floor 22 of the bag caddy 10. In such an exemplary embodiment, the cradle 48 may define a position in the vertical dimension from the floor 22 of the bag caddy 10 relative to the sensor arm 43 and load cell 44 different from the position of the floor 22 itself. In such embodiments, an extension 55 can facilitate different locations in the vertical dimension of the sensor arm 43 and load cell 44 as well as different arrangements of the floor 22, exemplarily with greater or lesser pitch relative to the floor 22 at the front wall 6 of the bag caddy 10.

As best seen in FIGS. 5 and 6, the dispenser 14 includes a sensor arm 43 which holds a load cell 44. As described in further detail herein, the cradle 48 facilitates engagement and positioning between the bag caddy 10 and the load cell 44 on the sensor arm 43. The arms 51 exemplarily align the cradle 48 (and bag caddy 10) in a lateral dimension, while the flanges 53 facilitate sliding engagement of the cradle 48 and rough alignment thereof on the sensor arm 43. The sectional view of FIG. 6 further depicts the compressor 39 and evaporator 41 of the dispenser 14. It will be recognized that in refrigerated embodiments of the dispenser 14, the refrigeration may exemplarily by provided by such a compressor 39 and evaporator 41 as depicted herein or in other manners as would be recognized by a person of ordinary skill in the art. In further embodiments, the dispenser 14 may alternatively include a heated cabinet or a cabinet 12 with no or limited environmental control.

It will be recognized that in use, a bag filled with liquid to be dispensed is placed within the bag caddy 10 and the bag caddy 10 is positioned within the cabinet 12 in a generally sliding manner. However, for the load cell 44 to properly measure a load impressed upon the load cell by a portion of the combined weight of the bag of liquid and the bag caddy, the bag caddy 10 must be supported on the load cell 44 free from support at other locations about the load cell 44. Therefore, the bag caddy must rest on the load cell with the back end of the bag caddy supported by the load cell. The front end of the bag caddy is pivotably supported by engagement of the ends 42 of the feet 38 with the trough 46. Consistently repeatable positioning of the feet 38 within the trough 46 facilitates consistent and repeatable calculations of valve open time for dispense of requested portions of liquid. However, as a bag caddy containing a bag of liquid is slid within the cabinet 12, elevating the back end of the bag caddy 10 above the load cell 44 on the sensor arm 43 for positioning can be a challenge.

Embodiments of the bag caddy 10 further include a leg 50 that projects generally downwardly from a bottom surface of the floor 22. In an embodiment, the leg 50 is exemplarily configured to facilitate loading of the bag caddy when filled with a bag of liquid into the cabinet 12 of the dispenser 14 by slidingly engaging a floor 52 of the cabinet 12. This sliding engagement of the floor 52 with the leg 50 enables a user to keep the back end of the bag caddy 10 and the cradle 48 elevated to a height such that the cradle 48 can properly engage the load cell 44. In an embodiment, the leg 50 may be dimensioned such that once the bag caddy 10 is in place with the cradle 48 properly engaging the load cell 44 and the feet 38 properly positioned within the dispenser 14, that the leg 50 does not engage the floor 52 of the cabinet 12. Rather, a sufficient space is provided such that even under an operable weight of the bag caddy 10 (and bag of liquid), the leg 50 does not engage the floor 52 to prevent any impact on the reading of the load cell 44. In another exemplary embodiment, the floor 52 of the cabinet 12 may be configured with at least one projection 54 to further facilitate the positioning of the cradle 48 relative to the load cell 44 as the bag caddy 10 is moved into place within the cabinet 12. In such an exemplary embodiment, as the leg 50 progresses into the cabinet 12 and over the projection 54, the cradle 48 is lifted up over the load cell 44 and as the leg 50 descends a back side of the projection 54, the cradle 48 engages the load cell 44 in a desired position which may be facilitated by the arms 51 and/or flanges 53. With the back end of the bag caddy 10 supported by the load cell 44 in the cradle 48, the leg 50 is positioned free from engagement with the floor 52 or the projection 54.

The cooperation of the bag caddy 10 with the dispenser 14 facilitates a user's placement of the filled bag caddy 10 into the dispenser 14. As stated above, accurate operation of the valve of the dispenser to dispense the liquid from the bag in the bag caddy requires consistent and accurate placement of the bag caddy within the dispenser so that the measurements of a portion of the weight of the bag of liquid and bag caddy as measured by the load cell 44 is accurate and repeatable. The leg and projection interact to lift the back end bag caddy to a height above the load cell for proper positioning the cradle 48 thereon. The legs engage the trough for repeatable positioning therein. The cradle 48 centers the caddy relative to the load cell. Thus the bag caddy is accurately and repeatably positioned in three dimensions relative to the load cell.

As best depicted in FIG. 2, embodiments of the bag caddy 10 further include a support plate 57 located generally at the front and bottom of the bag caddy 10. The support plate 57 as described in further detail herein supports a fitment 62 of a bag 64 of liquid (depicted e.g. FIG. 7). The flexible tube 68 of the bag 64 exemplarily extends from the fitment. Embodiments of the support plate 57 are connected to the floor 22 and/or front wall 16 exemplarily in the area about the cut-out 4.

The support plate 57 includes an opening 56 defined at least partially by a lip 58 and a slot 60. In an exemplary embodiment, the lip 58 defines an at least partially circular shape of the opening 56. By way of reference to FIGS. 2 and 7, the opening 56 is arranged to receive, through the slot 60 a fitment 62 of a bag of liquid 64. In an embodiment, the lip 58 is configured to engage the fitment 62 in a manner such as to secure the fitment 52 within the opening 56. In an embodiment, the lip 58 includes projections 66 which are configured to retain the fitment 62 within the opening 56. In an embodiment, a flexible tube 68 extends from the fitment 62. The flexible tube 68 is configured to be engaged by the pinch valve 70 (e.g. FIG. 4) and the liquid in the bag 64 dispensed therethrough by the dispenser 14.

FIG. 7 depicts an exemplary embodiment of a bag caddy 10 being loaded with a bag of liquid to be dispensed. In an exemplary embodiment, if a bag of liquid is to be loaded or replaced in a dispenser, the bag caddy 10 is removed from the dispenser and exemplarily laid on the side wall 20. The side door 24 is then operable to be moved (e.g. by pivoting and/or translation) into an open position as depicted in FIG. 5. If an empty bag (not depicted) is located within the bag caddy 10, this can then be removed through the open side door 24. The open side door 24 enables a user to place a bag 64 of liquid into the bag caddy 10 in a manner that requires less physical strength due to the larger opening and lower dimension of the front wall 16 and rear wall 18 when the bag caddy is resting on the side wall 20. Opening of the side door 24 further exposes the opening 56 in the support plate to receive and engage the fitment 62 of the bag 64. As depicted, embodiments of the bag caddy 10 with a side door 24 enable the bag 64 to be laid into the bag caddy 10 at which time the fitment 62 can be securely positioned within the opening 56.

After the bag 64 is loaded into the bag caddy 10, the side door 24 is moved into the closed position exemplarily depicted in FIG. 1. In an exemplary embodiment, when the side door 24 is in the closed position, the bottom lip 28 of the side door 24 may further extend across the opening 56 to engage the fitment of the bag further securing the fitment into placement within the opening. After the full bag has been loaded into the bag caddy 10, the bag caddy 10 may be placed into the cabinet 12 of a dispenser 14.

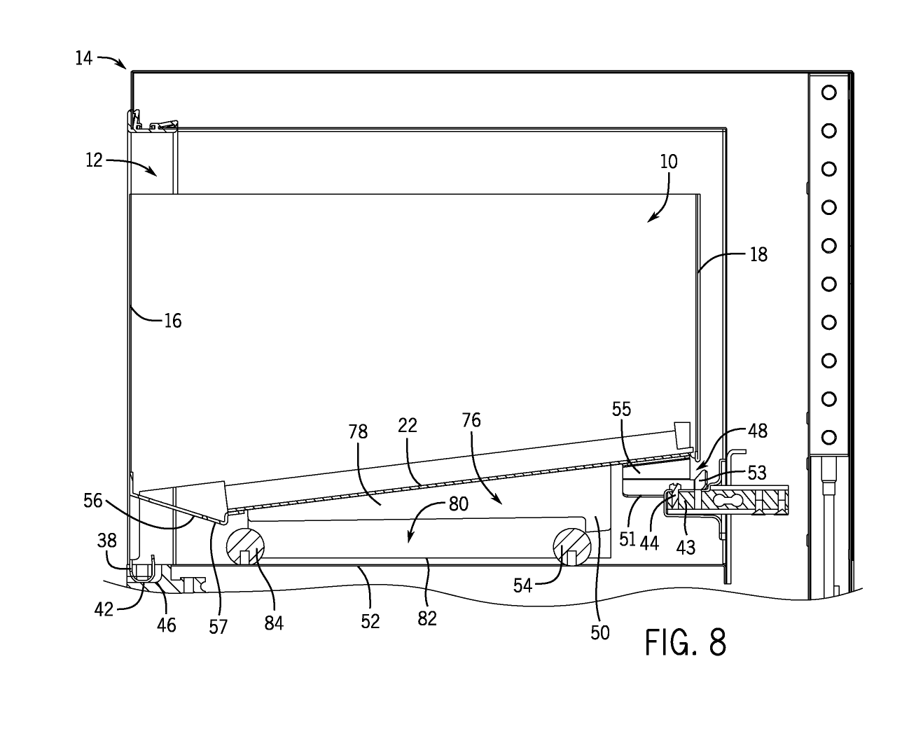

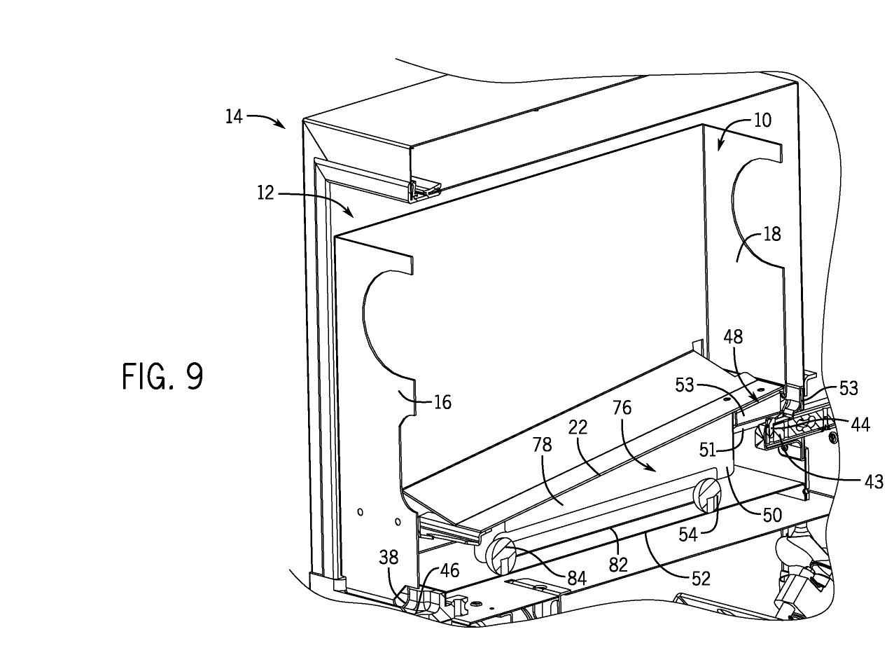

FIGS. 8 and 9 depict an additional exemplary embodiment of a bag caddy 10. It will be recognized that like reference numerals are used to refer to like structures between the Figures for conciseness and clarity. Both FIGS. 8 and 9 are cross sectional views of the bag caddy 10 positioned within a cabinet 12 of a dispenser 14. As previously described, the bag caddy 10, when filled with a bag of liquid to be dispensed needs to be positioned within the cabinet 12 in a manner that engages the load cell 44 on the sensor arm 43 with the cradle 48 of the bag caddy 10. This must be done in a manner which supports the bag caddy so that the cradle 48, floor 22, back wall 18, or some other portion of the bag caddy 10 does not damage the load cell 44 or sensor arm 43, while enabling the consistent and repeatable positioning of the bag caddy 10 relative to the load cell 44.

The bag caddy 10 includes a caddy guide 76 which further includes the leg 50. The caddy guide 76 also includes an elongated support 78 that extends toward the front of the bag caddy from the leg 50. The elongated support 78 further defines a channel 80 in a lower or bottom side thereof, open towards the floor 52 of the dispenser 14. In an exemplary embodiment, the channel 80 may be semi-circular or U-shaped, while it will be recognized that in alternative embodiments, other cross-sectional shapes of the channel 80 may be used. The elongated support 78 is angled relative to the floor 22 of the bag caddy 10. The elongated support 78 is connected to an underside of the floor 22 and the angle quality of the elongated support 78 arranges the caddy guide 76 on the bag caddy 10 in a manner such that a guide bottom 82 of the caddy guide 76 is held generally parallel to a floor 52 of the cabinet 12.

The cabinet 12 further includes projection 54, as well as, in certain embodiments, support projection 84. As depicted in FIGS. 8 and 9, the projection 54 and support projection 84 may exemplarily be spherical in shape, although it will be recognized that other shapes of projections may be used. In embodiments, the rounded profile or spherical shaped projections match the semi-circular or U-shaped cross section of the channel 80, while the rounded profile helps to promote alignment between the support projections and the caddy guide 76.

In use, the bag caddy 10 is filled with a bag of liquid to be dispensed (not depicted) and the bag caddy 10 is inserted into the cabinet 12, leading with the back wall 18. In order to support the weight of the bag caddy 10 containing the bag of liquid to be dispensed, the caddy guide 76 engages the support projection 84. Exemplarily, the leg 50 of the caddy guide 76 engages the support projection 84 and the leg 50 translates over the support projection 84, or in other words, the support projection 84 passes through a portion of the channel 80 that extends below the leg 50. In an exemplary embodiment, a user may tilt the bag caddy 10 so as to angle the bag caddy 10 and caddy guide 76 to make it easier for the leg 50 to pass over the support projection 84. Upon doing so, the support projection 84 engages the channel 80 of the caddy guide 76 which generally aligns the bag caddy 10 within the cabinet 12 relative to the sensor arm 43 with the load cell 44. Further insertion of the bag caddy 10 into the cabinet 12 is facilitated by a sliding engagement of the support projection 84 within the channel 80. In an exemplary embodiment, materials for the support projection 84 and/or caddy guide 76 may be selected to minimize or reduce friction between these components which may further facilitate translation of the bag caddy 10 within the cabinet 12. Engagement between the support projection 84 and the channel 80 helps to maintain the guide bottom 82 generally parallel to the cabinet 12, although it will be recognized that in use the bag caddy 10 may pivot about the engagement with the support projection 84. To this end, it will be recognized that upon further insertion of the bag caddy 10 into the cabinet 12 a front end of the leg 50 of the caddy guide 76 will engage the projection 54 at which point, a user can pivot the bag caddy 10 about the fulcrum provided by the support projection 84 to facilitate lifting the leg 50 of the caddy guide 76 over the projection 54. As the leg 50 and caddy guide 76 lift over the projection 54 the back end of the bag caddy 10, particularly the cradle 48 is also lifted to a position above the load cell 44 and sensor arm 43. Further insertion of the bag caddy 10 into the cabinet 12 can permit the user to place the foot 38 of the bag caddy 10 in the trough 46 of the dispenser 14 and further insertion of the bag caddy 10 moves the leg beyond the projection 54 and the projection 54 moves into the channel 80 while the bag caddy 10 pivots about the engagement of the foot 38 with the trough 46 to place the cradle 48 on the load cell 44 of the sensor arm 43. Upon this engagement, the bag caddy 10 is supported at the rounded end 42 of the cradle 38 within the trough 46 and at the engagement of the cradle 48 with the load cell 44. The support projection 84 and projection 54 are free from contact with the bag caddy 10 by being positioned at least partially within the channel 80, but free from contact with the caddy guide 76.

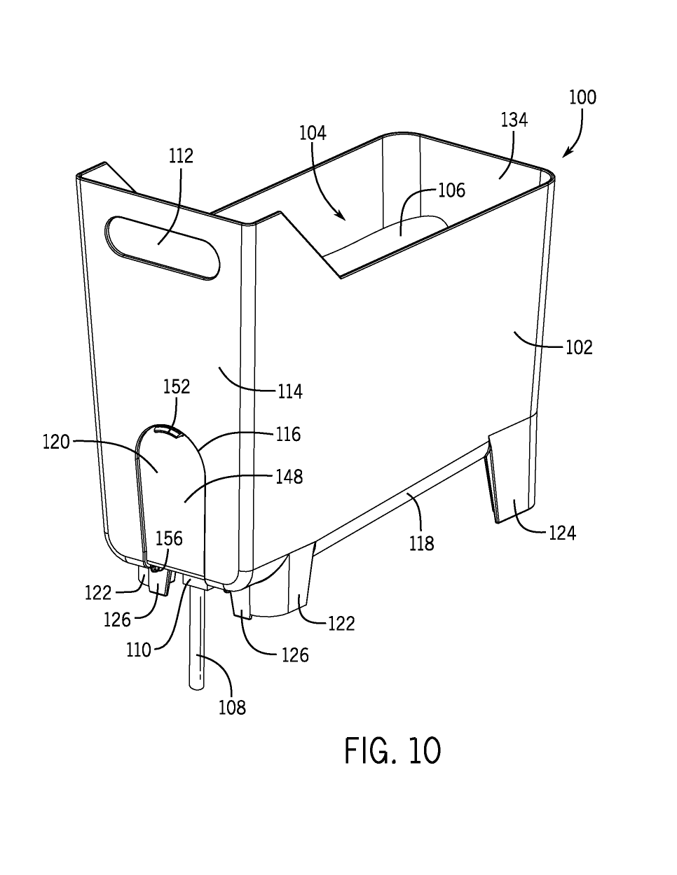

FIGS. 10-13 depict an additional exemplary embodiment of a bag caddy 100. The bag caddy 100 includes a caddy body 102 with an open interior 104 in which a bag 106 filled with a liquid to be dispensed is positioned as described in further detail herein. A flexible tube 108 extends from a fitment 110 at an end of the bag 106. The caddy body 102 further includes a handle 112 which may be created with a through hole through a front wall 114 of the caddy body 102. The caddy body 102 further includes a cut out 116 that extends through the front wall 114, and exemplarily further extends through at least a portion of a floor 118 of the caddy body 102. A support plate 120 which will be described in further detail herein exemplarily secures about the fitment 110 and to the caddy body 102.

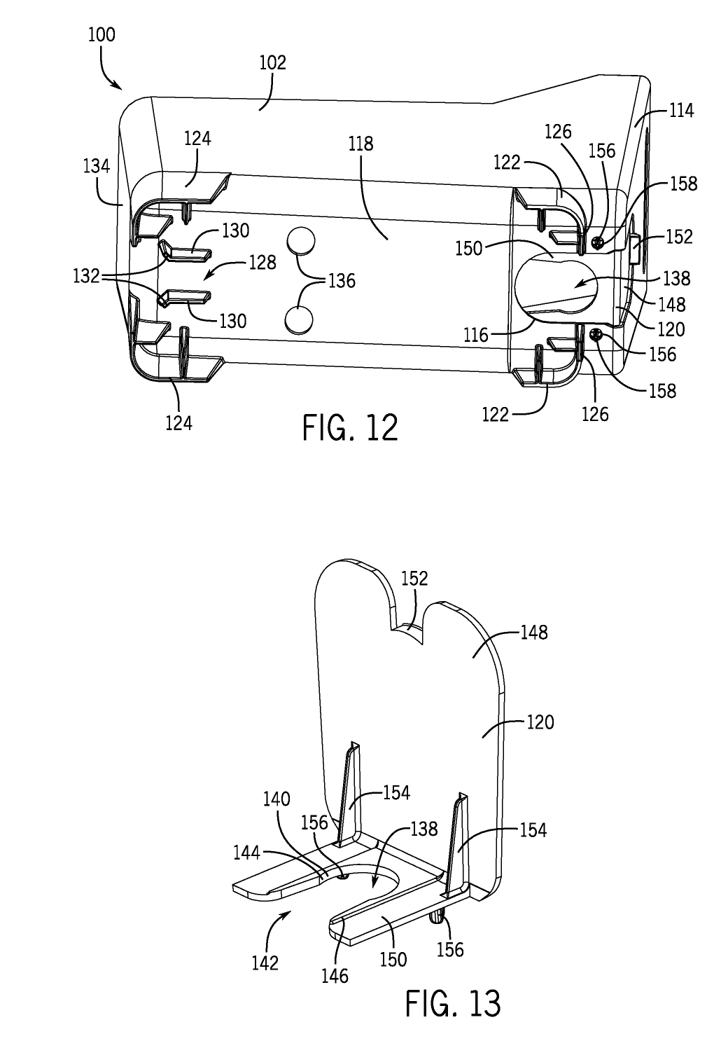

The bag caddy 100 further includes front legs 122 and rear legs 124. Feet 126 extend from the front legs 122. The feet 126 exemplarily engage a trough of a dispenser as described above with regards to other embodiments. It will be understood that in additional examples of the bag caddy 100, the size of front legs 122 may be reduced to the more commensurate in size with the feet 126. In still further embodiments, the feet 126 may be dimensioned so as to fit within a trough as described above, including, but not limited to various dimensions of troughs and, apart from those merely exemplary embodiments as disclosed and depicted herein. It will be recognized that rear legs 124 may alternatively be another number of legs, including a single leg as depicted and described previously. Additionally, the legs 124, as depicted in FIGS. 10 and 12 are located at positions about the cradle 128. In embodiments, the legs 124 may be located even with or rearwardly of the cradle 128.

The bag caddy 100 further includes a cradle 128 that extends from the bottom of the floor 118. The cradle 128 is exemplarily defined by arms 130 and flanges 132. The arms 130 and flanges 132 of the cradle 128 open in a direction towards the back wall 134 of the caddy body 102. The cradle 128 with the arms 130 and flanges 132 facilitate alignment of the bag caddy 100 with a sensor arm (not depicted) which includes a load cell (not depicted) in use to position the bag caddy 100 and engagement with the load cell as described above with respect to other exemplary embodiments.

Exemplary embodiments of the bag caddy 100 further include drain holes 136 through the floor 118. In an embodiment, the drain holes 136 may facilitate cleaning and/or direct any spilled liquid away from the flexible tube 108 from which the liquid is dispensed, which may facilitate improved cleanliness of the flexible tube 108 and/or dispensing valve (not depicted) of the dispenser as described above.

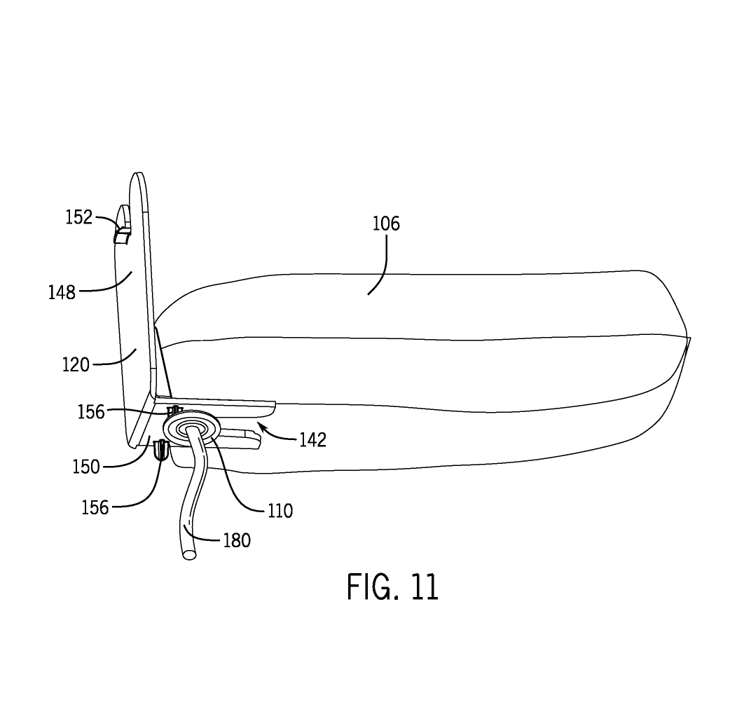

FIGS. 11 and 13 further depict the support plate 120, although the support plates 120 is also depicted in FIGS. 10 and 12 as well. The support plate 120 includes a front plate 148 and a floor plate 150. The front plate 148 and the floor plate 150 may further be connected by braces 154 which provide strength and rigidity to the support plate 120. The front plate 148 includes a tab 152 that extends outwardly from the front plate 148. The tab 152 is arranged to engage the front wall 114 by extending through the cutout 116. The tab 152 engages the front wall 114 exemplarily by a friction fit or a deformation of the tab 152 caused by engagement with the front wall 114. In embodiments, the tab 152 may include a projection or a lip which further facilitates such engagement with the front wall 114.

The floor plate 150 further includes and opening 138 that is dimensioned to receive and hold the fitment 110 of the bag 116. The floor plate 150 further includes a slot 142 extending to the opening 138 from one end of the floor plate 150. In use, the fitment is slidingly received into the opening 138 through the slot 142. A lip 140 defined by the edge of the opening 138 through the floor plate 150 engages between corresponding structures (e.g. rings or lips on the fitment 110). In an exemplary embodiment, the floor plate 150 includes a ridge 146 about the opening 138 and slot 142 which is keyed or otherwise dimensioned to fit a single alignment or engagement with the fitment 110 of the bag 106. Projections 144 extend inwardly into the slot 142, exemplarily continuing the circumference of the opening 138. In an exemplary embodiment, the projections 144 extend the circumference of the opening 138 to an amount greater than 180 degrees of the circumference. The projections 144 help to secure the fitment 110 in the position defined by the opening 138.

The floor plate 150 further includes prongs 156 which extend from a bottom of the floor plate 150. The prongs 156 exemplarily fit within aperture 158 in the floor 118 of the caddy body 102. The engagement of the prongs 156 within the apertures 158 cooperate with engagement of the tab 152 with the front wall 114 to secure the support plate 120 across the cut out 116 to hold the fitment and flexible tube 108 in a predefined position.

In use, as exemplarily depicted in FIG. 11, a person seeking to load a bag 106 within the bag caddy 100 first positions the support plate 120 about the fitment 110 to locate the fitment 110 within the opening 138, and secured therein by the projections 114 and ridge 146. The combined bag 106 and support plate 120 are inserted into the bag caddy 100 from the top and the flexible tube 108 is easily extended through the cutout 116 in the caddy body 102. The prongs 156 and tab 152 of the support plate 120 are then engaged respectively with the front wall 114 and apertures 158 of the caddy body 102. This secures the support plate 120 to the caddy body 102 and orients the fitment 110 with the flexible tube 108 in a predetermined position relative between the apertures 158, prongs 156, opening 138 and tab 152.

To load the bag caddy 100 into a dispenser (not depicted) the bag caddy 100 may be placed into the cabinet of the dispenser and translated within the cabinet while supported by the rear legs 124. This may occur until the bag caddy can be elevated or at least the back wall 134 of the bag caddy 100 elevated in order to position the feet 162 of the front legs 122 within the trough of the dispenser as described in embodiments above. After the feet 126 are located in the trough of the dispenser, the bag caddy 100 may be rotated about the feet 126 in the trough to position the cradle 128 on the load cell of the sensor arm of the dispenser. The handle 112 may facilitate user gripping and pivoting of the bag caddy as described above. Once the bag caddy 100 is loaded in the dispenser, the bag caddy 100 creates a mechanical system whereby the weight of the bag caddy with the bag of liquid to be dispensed is supported at one end by the load cell within the cradle and at the front end at fulcrum defined by the engagement of the feet 126 with the trough of the dispenser. The fitment 110 and flexible tube 108 are also located at a predetermined position which is exemplarily directly in alignment with the pinch valve 70 and exemplarily the tube seat 74 as depicted in FIG. 3. The known positions and orientations of these components facilitate accurate and repeatable calculations of valve open times for accurate dispense of requested volumes from the bag of liquid.

In a further exemplary embodiment, to replace a used bag 106, after the pinch valve is disengaged from the tube 108, the user may press inward on the front plate 148, and disengage the tab 152 from the front wall 114 to push the front plate 148 inward into the open interior 104 of the bag caddy 100. An upward force on the floor plates 150 disengages the prongs 156 from the apertures 158 to release the support plate 120 from engagement with e caddy body 102. In embodiments, the support plate 120 may then be rotated exemplarily 90 degrees or another angular rotation as may be recognized by a person of ordinary skill in the art and the support plate 120 withdrawn from the bag caddy 100 through the cutout 116. The rest of the bag 106 may also be withdrawn through the cutout 116 and disposed of, leaving the caddy body 102 to be removed from the cabinet of the dispenser.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A caddy for use in supporting a flexible bag of a substance to dispense, the caddy comprising:
a front wall;
a back wall opposite the front wall;
a first side wall and a second side wall;
a floor extending between the front wall and the back wall, the floor angling from the back wall in a direction towards the front wall; and
a cradle connected to the floor, the cradle open in a downward direction and a rearward direction.

2. The caddy of claim 1, further comprising at least one foot extending downward from a region about the front wall.

3. The caddy of claim 2, further comprising at least one leg extending downward from the floor.

4. The caddy of claim 3, wherein the at least one leg is at least a first leg and a second leg, the first and second legs arranged about the cradle.

5. The caddy of claim 3, further comprising a caddy guide connected to the floor, the caddy guide comprising the at least one leg and an elongated support defining a channel therein.

6. The caddy of claim 1, wherein the first side wall is a door movably secured to the first side wall and the second side wall, the door movable between a closed position wherein the door resiliently engages the floor and an open position wherein the door is disengaged from the floor.

7. The caddy of claim 1, wherein the cradle further comprises first and second arms, the first and second arms being spaced apart and extend downwardly, and, a flange extending outwardly from each of the first and second arms.

8. The caddy of claim 1, further comprising a support plate connected to at least one of the front wall and the floor.

9. The caddy of claim 7, wherein the support plate is adapted to be secured to the flexible bag.

10. The caddy of claim 7, wherein the support plate removably connected to the caddy.

11. A system for dispensing a substance, the system comprising:
a dispenser comprising at least a cabinet, a load cell, a valve, and a processor, the processor calculates a valve open time at least in part based upon a measurement of a load impressed upon the load cell and a requested dispense volume, the processor operates the valve to open for the valve open time;
a caddy comprising a front wall, a back wall opposite the front wall, a first side wall, a second side wall, and a floor extending between the front wall and the back wall, the floor angling from the back wall in a direction towards the front wall, and a cradle connected to the floor, the cradle opening in a downward direction and a rearward direction to engage the load cell; and
a flexible bag disposed within the caddy and containing a substance to be dispensed, a flexible tube extending from the flexible bag and connected to the valve.

12. The system of claim 11, further comprising a support plate, the support plate comprising at least a lip defining an opening, a fitment of the flexible bag removably received within the opening by engagement with the lip.

13. The system of claim 12, wherein the support plate defines a predetermined position of the flexible tube extending from the fitment of the flexible bag relative to the valve when the caddy is positioned within the dispenser.

14. The system of claim 13, wherein the support plate is removably secured to the caddy.

15. The system of claim 11, wherein the dispenser further comprises at least one trough and the caddy comprises a first foot and a second foot extending downward therefrom from opposing sides of the support plate, the first foot and the second foot pivotably engage the at least one trough to define a position of the caddy within the dispenser relative to the load cell.

16. The system of claim 15, wherein the at least one trough and the first foot and the second foot all comprising mating curved surfaces.

17. The system of claim 15, wherein the cradle engages the load cell and further defines the position of the caddy within the dispenser relative to the load cell.

18. The system of claim 11, further comprising at least one leg extending downward from the floor of the caddy, and the dispenser comprises a first projection extending upward from a floor of the cabinet and a sensor arm comprising the load cell, the sensor arm extending into the cabinet, and wherein when the caddy is inserted into the cabinet, the at least one leg engages the at least one projection to position the cradle over the sensor arm and onto the load cell.

19. The caddy of claim 18, wherein the dispenser comprises a second projection extending upward from the floor of the cabinet and the caddy comprises a caddy guide connected to the floor of the caddy, the caddy guide comprising the at least one leg and an elongated support defining a channel therein, wherein when the caddy is inserted into the cabinet, the second projection is at least partially received within the channel and the caddy translates along an engagement of the second projection and the caddy guide.

20. The system of claim 11, further comprising a first leg and a second leg, the first leg and the second leg extend downwardly from the floor of the caddy adjacent the cradle.
